(19) United States
(12) Patent Application Publication
(10) Pub. No.: US 2024/0010812 A1
(43) Pub. Date: Jan. 11, 2024

(54) FLAME-RETARDANT PULVERULENT COMPOSITION AND 3D-PRINTED OBJECT OBTAINED FROM THE SAME

(71) Applicant: BASF SE, Ludwigshafen am Rhein (DE)

(72) Inventors: Wei Zheng FAN, Shanghai (CN); Yan Sheng Ll, Shanghai (CN); Li CHEN, Shanghai (CN); Zhi Zhong CAI, Shanghai (CN); Xia MENG, Shanghai (CN)

(21) Appl. No.: 18/037,337

(22) PCT Filed: Nov. 16, 2021
(86) PCT No.: PCT/EP2021/081817

§ 371 Date: May 17, 2023

(30) Foreign Application Priority Data
Nov. 19, 2020 (WO) PCT/CN2020/130

(51) Int. Cl. C08K 3/32; C08L 77/00; C08K 5/3492; B33Y 70/00

(52) U.S. Cl. CPC C08K 3/32; C08L 77/00; C08K 5/34928; B33Y 70/00; C08L 2205/025; C08L 2201/02; C08K 2003/329; C08K 2003/323; B29C 64/153

(57) ABSTRACT

The present disclosure relates to a pulverulent composition comprising (a) at least one phosphate flame retardant synergist selected from hydrogen phosphate salt, dihydrogen phosphate salt, hydrate thereof and mixture thereof; (b) at least one flame retardant; and (c) at least one thermoplastic polymer. The present disclosure also relates to a 3D-printed object formed from the pulverulent composition and a process of forming 3D-printed object. The pulverulent composition shows good printability and the 3D-printed objects obtained from the thermoplastic powders not only have excellent flame-retardant performance but also have good mechanical properties.

### Technology Field

The present invention relates to a flame-retardant pulverulent composition, further relates to a 3D-printed object formed from the flame-retardant pulverulent composition as well as a process of forming the 3D-printed object.

BACKGROUND 3D-printing technologies using thermoplastic powders, e.g. selective laser sintering (SLS), multi jet fusion (MJF) and selective heat sintering (SHS), have been used for rapid prototyping and rapid manufacturing processes. These technologies often require the thermoplastic powders having good flame-retardancy performance. To obtain the 3D-printed objects based on thermo-plastic powders with good flame-retardancy performance, flame retardant additive is one of main components being used so as to increase the limiting oxygen index of the thermoplastic powders. Although, the addition of certain amount of flame-retardant additive can provide good flame-retardancy performance, the mechanical properties of the resulted 3D-printed objects are often decreased due to the decrease of the interaction and entanglement of polymers. Therefore, there is a strong need to provide the thermoplastic powders with good printability in 3D printing process by SLS, MJF or SHS, meanwhile the thermoplastic powders and the 3D-printed objects have excellent flame-retardant performance and the 3D-printed objects still have good mechanical properties.

### SUMMARY OF THE INVENTION

It is an object of the invention to provide a pulverulent composition comprising a flame retardant synergist, flame retardant and thermoplastic polymer, wherein the pulverulent composition shows good printability in 3D printing process and the 3D-printed objects obtained from the pulverulent composition not only have excellent flame-retardant performance but also have good mechanical properties.

Another object of the present invention is to provide a 3D-printed object formed from the pulverulent composition of the present invention.

A further object of the present invention is to provide a process of forming 3D-printed object by using the pulverulent composition of the present invention.

It has been surprisingly found that the above objects can be achieved by following embodiments:
1. A pulverulent composition comprising
(a) at least one phosphate flame retardant synergist selected from hydrogen phosphate salt, dihydrogen phosphate salt, hydrate thereof and mixture thereof;
(b) at least one flame retardant; and
(c) at least one thermoplastic polymer.
2. The pulverulent composition according to item 1, wherein the hydrogen phosphate salt and dihydrogen phosphate salt are hydrogen phosphate metal salt and dihydrogen phosphate metal salt, respectively.
3. The pulverulent composition according to item 2, wherein the metal in the hydrogen phosphate metal salt and dihydrogen phosphate metal salt is a metal selected from the group consisted of an alkali metal, alkaline earth metal, the metals of Group IIIA of the Periodic Table of Elements and transition metal.
4. The pulverulent composition according to item 2 or 3, wherein the metal in the hydrogen phosphate metal salt and dihydrogen phosphate metal salt is a metal selected from the group consisted of alkaline earth metal, the metals of the Groups IIIA, IIB, IIIB, IVB and VIII of the Periodic Table of Elements, preferably selected from Ca, Mg, Al, Zr, Fe and Mn, more preferably from Mg, Ca, Al and Zr.
5. The pulverulent composition according to any of items 1 to 4, wherein the amount of component (a) is in the range from 0.1 to 30 wt. %, preferably from 1 to 20 wt. %, based on the total weight of the pulverulent composition.
6. The pulverulent composition according to any of items 1 to 5, wherein the flame retardant is selected from the group consisted of phosphorus-based flame retardants, metal hydroxide compounds, melamine-based compounds, antimony compounds, borate compounds, other metal containing flame retardants, silicon-based materials; and mixtures thereof.
7. The pulverulent composition according to item 6, wherein the flame retardant is selected from the group consisted of phosphorus-based flame retardants and melamine-based compounds.
8. The pulverulent composition according to any of items 1 to 7, wherein the amount of the flame retardant as component (b) is in the range from 5 to 60 wt. %, preferably from 10 to 50 wt. %, more preferably 10 to 30 wt. %, based on the total weight of the pulverulent composition.
9. The pulverulent composition according to any of items 1 to 8, wherein the weight ratio of component (a) to component (b) is in the range from 20:1 to 1:50, preferably from 10:1 to 1:20, more preferably 2:1 to 1: 10.
10. The pulverulent composition according to any of items 1 to 9, wherein the total amount of component (a) and component (b) is in the range from 6 to 70 wt. %, preferably from 15 to 55 wt. %, based on the total weight of the pulverulent composition.
11. The pulverulent composition according to any of items 1 to 10, wherein the thermoplastic polymer is selected from the group consisted of polyolefins, hydrocarbon resins, aromatic homopolymers and copolymers derived from vinyl aromatic monomers, halogen-containing poly-mers, polymers derived from α,β-unsaturated acids and derivatives thereof, polymers derived from unsaturated alcohols and amines or the acyl derivatives or acetals thereof, homopolymers and copolymers of cyclic ethers, polyacetals, polyphenylene oxides and sulphides, polyamides and co-polyamides, polyureas, polyimides, polyamide imides, polyether imides, polyester imides, polyhydantoins, polybenzimidazoles, polyesters, polyketones, polysulphones, polyether sul-phones, polyether ketones, polycarbonates, polyurethanes and blends or mixtures of the aforementioned polymers.
12. The pulverulent composition according to any of items 1 to 11, wherein the thermoplastic polymer is selected from the group consisted of polyamides and co-polyamides, polyolefins, polyester and polyurethanes, and blends or mixtures of the aforementioned polymers.
13. The pulverulent composition according to any of items 1 to 12, wherein the average particle size (D₅₀) of the thermoplastic polymer is in the range from 0.1 to 1000 μm or from 0.1 to 500 μm or from 0.1 to 300 μm.
14. The pulverulent composition according to any of items 1 to 13, wherein the amount of the thermoplastic polymer is in the range from 20 to 94 wt. %, preferably from 30 to 90 wt. %, more preferably from 50 to 90 wt. % based on the total weight of the pulverulent composition.
15. The pulverulent composition according to any of items 1 to 14, wherein the pulverulent composition comprises at least one flowing agent.
16. A 3D-printed object formed from the pulverulent composition according to any of items 1 to 15.
17. A process of forming 3D-printed object, comprising using the pulverulent composition according to any of items 1 to 15.
18. The process according to item 17, wherein the process comprises:
   a) adding the pulverulent composition according to any of items 1 to 15 to a molding mixture, and
   b) producing the molding by selectively bonding the powder.

19. The process according to item 18, wherein the molding produced in step b) is produced by a process for the layer-by-layer build-up of three-dimensional objects by selectively bonding portions of a powder to on another.
20. The method according to item 18 or 19, wherein the selectively bonding comprises selective laser sintering, selective inhibition of the bonding of powders, 3D printing, or a microwave process.

The pulverulent composition according to the present invention comprises a special combination of the flame retardant and the flame retardant synergist and has excellent flame-retardant properties, especially both excellent printability and flame-retardant properties. The printed object obtained from said pulverulent composition shows excellent flame-retardant properties, especially both excellent flame-retardant properties and good mechanical properties, comparing with the printed object obtained from the pulverulent composition only containing the flame retardant synergist or the flame retardant.

### DESCRIPTION OF THE DRAWING

FIG. 1 shows the picture of printed samples prepared from the pulverulent composition of example 1b.

FIG. 2 shows the picture of printed samples prepared from the pulverulent composition of example 2b.

FIG. 3 shows the picture of printed samples prepared from the pulverulent composition of example 3b.

FIG. 4 shows the picture of printed objects prepared from the pulverulent composition of example 2b.

### EMBODIMENT OF THE INVENTION

The undefined article “a”, “an”, “the” means one or more of the species designated by the term following said article.

In the context of the present disclosure, any specific values mentioned for a feature (comprising the specific values mentioned in a range as the end point) can be recombined to form a new range.

One aspect of the present invention is directed to a pulverulent composition comprising
(a) at least one phosphate flame retardant synergist selected from hydrogen phosphate salt, dihydrogen phosphate salt, hydrate thereof and mixture thereof;
(b) at least one flame retardant; and
(c) at least one thermoplastic polymer.

According to the present invention, the hydrogen phosphate salt and dihydrogen phosphate salt as component (a) are hydrogen phosphate metal salt and dihydrogen phosphate metal salt, respectively. The metal in the hydrogen phosphate metal salt and dihydrogen phosphate metal salt can be a metal selected from the group consisted of an alkali metal, alkaline earth metal, Group IIIA of the Periodic Table of Elements and transition metal such as the metal from Groups IIB, IIIB, IVB, VIIB and VIII of the Periodic Table of Elements. In a preferred embodiment, the metal in the hydrogen phosphate salt and dihydrogen phosphate salt is a metal selected from the group consisted of alkaline earth metal, the metals of the Groups IIIA, IIB, IIIB, IVB and VIII of the Periodic Table of Elements, preferably selected from Ca, Mg, Al, Zr, Fe and Mn, more preferably from Mg, Ca, Al and Zr, especially Al and Zr.

The specific examples of the hydrogen phosphate salt and dihydrogen phosphate salt can includes, for example magnesium hydrogen phosphate, magnesium dihydrogen phosphate, calcium hydrogen phosphate and calcium dihydrogen phosphate, manganese (Ill) hydrogen phosphate, manganese (III) dihydrogen phosphate, iron hydrogen phosphate, iron dihydrogen phosphate, zinc hydrogen phosphate, zinc dihydrogen phosphate, cadmium hydrogen phosphate, cadmium dihydrogen phosphate, aluminum hydrogen phosphate, aluminum dihydrogen phosphate, tin hydrogen phosphate, tin dihydrogen phosphate, zirconium hydrogen phosphate and zirconium dihydrogen phosphate and hydrate thereof and mixture thereof.

Among them, preferred hydrogen phosphate salt and dihydrogen phosphate salt are magnesium hydrogen phosphate, magnesium dihydrogen phosphate, calcium hydrogen phosphate, calcium dihydrogen phosphate, aluminum hydrogen phosphate, aluminum dihydrogen phosphate, zirconium hydrogen phosphate and zirconium dihydrogen phosphate; hydrate thereof for example Zr(HPO₄)₂·H₂O; and mixture thereof.

The average particle size (D₅₀) of phosphate flame retardant synergist as component (a) can be in the range from 0.1 to 1000 μm, for example from 0.1 to 500 μm or from 0.1 to 300 μm.

According to the present invention, the amount of component (a) can be in the range from 0.1 to wt. %, for example 0.2 wt. %, 0.5 wt. %, 0.8 wt. %, 1.0 wt. %, 2 wt. %, 3 wt. %, 4 wt. %, 5 wt. %, 6 wt. %, 7 wt. %, 8 wt. %, 9 wt. %, 10 wt. %, 12 wt. %, 15 wt. %, 18 wt. %, 25wt%, 28wt%, preferably from 1 to 20 wt. %or 1 to 15 wt. %or 2 to 12 wt. %, based on the total weight of the pulverulent composition. As mentioned above, any specific values mentioned for a feature such as the amount of component (a) here can form a new range, for example from 0.2 to 30 wt. %or 2 to wt. % etc.

According to the present invention, the pulverulent composition comprises at least one flame retardant. According to a preferred embodiment, the flame retardant is a halogen-free flame retardant, i.e., free of chlorine and bromine.

The flame retardant can be selected from the group consisted of phosphorus-based flame retardants, metal hydroxide compounds, melamine-based compounds, antimony compounds, borate compounds, other metal containing flame retardants, silicon based materials; and mixtures thereof.

Phosphorus based flame retardants include those disclosed for example in, U.S. Pub. Nos. 2003/0220422, 2014/0005289, 2011/0257310 and 2014/0005289 and U.S. Pat. Nos. 3,966,894, 4,079,035, 4,107,108, 4,108,805, 4,174,343, 4,228,063, 6,265,599, 6,528,559, 6,740,695, 7,786,199 and 8,349,925. Phosphorous based flame retardant includes phosphazene compounds, triphenyl phosphates, phosphate esters, phosphonium derivatives, phosphonates, phosphoric acid esters, phosphate esters, phosphinate, hypophosphite, polyphosphate. Phosphorous based flame retardants are usually composed of a phosphate core to which is bonded alkyl (generally straight chain) or aryl (aromatic ring) groups. Examples include red phosphorous, inorganic phosphates, insoluble ammonium phosphate, ammonium polyphosphate, ammonium urea polyphosphate, ammonium orthophosphate, ammonium carbonate phosphate, ammonium urea phosphate, diammonium phosphate, ammonium melamine phosphate, diethylenediamine polyphosphate, dicyandiamide polyphosphate, polyphosphate, urea phosphate, melamine pyrophosphate, melamine orthophosphate, melamine salt of dimethyl methyl phosphonate, melamine salt of dimethyl hydrogen phosphite, ammonium salt of boronpolyphosphate, urea salt of dimethyl methyl phosphonate, organophosphates, phosphonates and phosphine oxide. Phosphate esters include, for example, trialkyl derivatives, such as triethyl phosphate, tris(2-ethylhexyl)phosphate, trioctyl phosphate, triaryl derivatives, such as triphenyl phosphate, cresyl diphenyl phosphate and tricresyl phosphate and aryl-alkyl derivatives, such as 2-ethylhexyl-diphenyl phosphate and dimethyl-aryl phosphates, octylphenyl phosphate and ethylene diamine phosphates.

Other examples of phosphorous based flame retardants include resorcinol-bis- diphenylphosphate, guanidine phenylphosphonate, melamine phenylphosphonate, phosphinate, such as dimethyl- aluminum phosphinate, methyl-ethylaluminumphosphinate, diethylaluminumphosphinate, hypophosphite, such as diethylaluminumhypophosphite; poly- [2,4-(piperazine-1,4-yl)-6-morpholine-4-yl)-1,3,5-triazine], aluminum polyphosphate, methylamine boron-phosphate, cyanuramide phosphate, magnesium phosphate, ethanolamine dimethyl phosphate, pentaerythritol-di-methylphosphonate, cyclic phosphonate ester, trialkyi phosphonates, potassium ammonium phosphate, cyanuramide phosphate, aniline phosphate, trimethylphosphoramide, tris(1-aziridinyl)phosphine oxide, bis(5,5-dimethyl-2-thiono-1,3,2- dioxaphosphorinamyl)oxide, dimethylphosphono-N-hydroxymethyl-3-propionamide, tris(2-butoxyethyl)phosphate, tetrakis(hydroxymethyl)phosphonium salts, such as tetrakis(hydroxymethyl)phosphonium chloride and tetrakis(hydroxymethyl)phosphonium sulfate, n-hydroxymethyl-3-(dimethylphosphono)-propionamide, a melamine salt of boron- polyphosphate, an ammonium salt of boron-polyphosphate, triphenyl phosphite, ammonium dimethyl phosphate, melamine orthophosphate, ammonium urea phosphate, ammonium melamine phosphate, a melamine salt of dimethyl methyl phosphonate, a melamine salt of dimethyl hydrogen phosphite and the like.

Preferred phosphinate are phosphinic salts of the formula (I) and/or diphosphinic salts of the formula (II) and/or their polymers

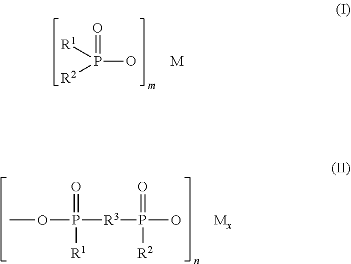

where the definitions of the substituents are as follows:
R¹ and R² are each independently hydrogen or C₁—C-alkyl, preferably C₁—C₄-alkyl, linear or branched, e.g. methyl, ethyl, n-propyl, isopropyl, n-butyl, tert-butyl, n-pentyl; phenyl;
R₃ is C₁—C₁₀-alkylene, linear or branched, e.g. methylene, ethylene, n-propylene, isopropylene, n-butylene, tert-butylene, n-pentylene, n-octylene, n-dodecylene; arylene, e.g. phenylene, naphthylene; alkylarylene, e.g. methylphenylene, ethylphenylene, tert-butylphenylene, methylnaphthylene, ethylnaphthylene, tert-butylnaphthylene; arylalkylene, e.g. phenylmethylene, phenylethylene, phenylpropylene, phenyl-butylene;
M is an alkaline earth metal or alkali metal, Al, Zn, Fe or boron;
m is a whole number from 1 to 3;
n is a whole number of 1, 2 and 3, and
x is 1 or 2.

Particular preference is given to compounds of the formula I or formula II in which R¹ and R² are each independently C₁—C₆-alkyl, especially, ethyl radicals, where M is preferably Zn, Ca or Al, and Al diethylphosphinate is particularly preferred. Particular preference is given to Al diethylphosphinate in a mixture with melamine cyanurate and/or melamine polyphosphate (from 3:1 to 1.5:1 by weight) as flame retardant system.

Metal hydroxide flame retardants include inorganic hydroxides, such as aluminum hydroxide, magnesium hydroxide, aluminum trihydroxide (ATH) and hydroxycarbonate.

Melamine based flame retardants are a family of non-halogenated flame retardants that include three chemical groups: (a) melamine (2,4,6-triamino-1,3,5 triazine); (b) melamine derivatives (including salts with organic or inorganic acids, such as boric acid, cyanuric acid, phosphoric acid or pyro/poly-phosphoric acid); and (c) melamine homologues. Melamine derivatives include, for example, melamine cyanurate (a salt of melamine and cyanuric acid), a salt of melamine and phosphoric acid (such as melamine-mono-phosphate), melamine pyrophosphate and melamine polyphosphate. Melamine homologues include melam (1,3,5-triazin-2,4,6- triamine-n-(4,6-diamino-1,3,5-triazine- 2-yl), melem (2,5,8-triamino 1,3,4,6,7,9,9b- heptaazaphenalene) and melon (poly[8-amino-1,3,4,6,7,9,9b-heptaazaphenalene-2,5-diyl).

Melamine based flame retardants are also melamine compound/polyol condensates. For instance, as disclosed in U.S. app. Ser. No. 10/539,097 (published as WO 2004/055029) and U.S. Pub. No. 2010/152376, where the polyol is a linear, branched or cyclic trihydric, tetrahydric, pentahydric or hexahydric alchol or a linear or cyclic C₄—C₆ aldose or C₄—C₆ ketose and where the melamine compound is melamine phosphate, melamine pyrophosphate or melamine polyphosphate. The polyol is preferably pentaerythritol or dipentaerythritol. The melamine compound is preferably melamine phosphate. The molar ratio of melamine compound to the polyol is preferably from about 1:1 to about 4:1. The condensate may further have incorporated therein a dendritic polymer substituted by hydroxy groups, for instance a dendritic polyester or dendritic polyamide. A dendritic polyester is preferably a product of an initiator compound selected from the group consisting of trimethyolpropane, pentaerythritol and ethoxylated pentaerythritol and chain-extending dimethylpropionic acid. A dendritic polyamide is preferably a polycondensate of a cyclic carboxylic acid anhydride and diisopropanolamine.

Borate flame retardant compounds include zinc borate, borax (sodium borate), ammonium borate, and calcium borate. Zinc borate is a boron-based flame retardant having the chemical composition xZnO_{y}B₂O₃·zH₂O. Zinc borate can be used alone, or in conjunction with other chemical compounds, such as alumina trihydrate, magnesium hydroxide or red phosphorous. It acts through zinc halide or zinc oxyhalide, which accelerate the decomposition of halogen sources and promote char formation.

Examples of other metal containing flame retardant substances, which can be employed alone or in combination with other flame retardant substances, include, but are not limited to, magnesium oxide, magnesium chloride, talcum, alumina hydrate, zinc oxide, alumina trihydrate, alumina magnesium, calcium silicate, sodium silicate, zeolite, sodium carbonate, calcium carbonate, ammonium molybdate, iron oxide, copper oxide, zinc phosphate, zinc chloride, clay.

Polytetrafluoroethylene (PTFE) is also contemplated as an anti-drip agent which can provide additional flame retardancy to the composition.

Silicon based materials are also included which are for instance silicone, such as linear or branched chain type silicone with (hydroxy or methoxy) or without (saturated hydrocarbons) functional reactive groups.

Suitable flame retardants are also those of U.S. patent applications Ser. Nos. 61/739842 and 61/835893, published as W02014/099397. For instance, a combination of one or more bismuth compounds selected from the group consisting of bismuth oxychloride, bismuth oxyfluoride, bismuth oxybromide, bismuth oxyiodide and bismuth oxynitrate and one or more organobromine flame retardants.

Preferably, the flame retardant is selected from the group consisted of phosphorus-based flame retardants, especially phosphate, polyphosphate, phosphinate, hypophosphite and melamine-based compounds.

The average particle size (D₅₀) of the flame retardant as component (b) can be in the range from 0.1 to 1000 μm, for example from 0.1 to 500 μm, from 0.1 to 300 μm or 0.1 to 100 μm.

The amount of the flame retardant as component (b) can be in the range from 5 to 60 wt. %, for example 8 wt. %, 11 wt. %, 12 wt. %, 13 wt. %, 14 wt. %, 15 wt. %, 16 wt. %, 18 wt. %, 20 wt. %, 25 wt. %, 28 wt. %, 30 wt. %, 35 wt. %, 40 wt. %, 45 wt. %, 50 wt. %or 55 wt. %, preferably from 10 to 50 wt. %or from 10 to 30 wt. %, based on the total weight of the pulverulent composition.

According to the present invention, the weight ratio of component (a) to component (b) can be in the range from 20:1 to 1:50, for example 18:1, 15:1, 12:1, 10:1, 8:1, 5:1, 2:1, 1:1, 1:1.5, 1:2, 1:4, 1:5, 1:8, 1:10, 1:20, 1:30, 1:40, 1:45, preferably from 10:1 to 1:20, more preferably 2:1 to 1:10.

The total amount of component (a) and component (b) can be in the range from 6 to 70 wt. %, for example, 15 wt. %, 18 wt. %, 20 wt. %, 25 wt. %, 30 wt. %, 35 wt. %, 40 wt. %, 45 wt. %, 50 wt. %, preferably from 10 to 60 wt. %, based on the total weight of the pulverulent composition.

According to the present invention, the pulverulent composition comprises at least one thermo-plastic polymer.

A list of suitable thermoplastic polymers is given below:
1. Polyolefins, such as polymers of monoolefins and diolefins, for example thermoplastic polyolefins (TPO), such as polypropylene, polyisobutylene, polybut-1-ene, poly-4-methylpent-1-ene, polyvinylcyclohexane, polyisoprene or polybutadiene, as well as polymers of cycloolefins, for instance of cyclopentene or norbornene, polyethylene (which optionally can be cross linked), for example high density polymethylene (HDPE), high density and high molecular weight polyethylene (HDPE-HMW), high density and ultrahigh molecular weight polyethylene (HDPE-UHMVV), medium density polyethylene (MDPE), low density polyethylene (LDPE), linear low density polyethylene (LLDPE), (VLDPE) and (ULDPE).
   Polyolefins, i.e. the polymers of monoolefins exemplified in the preceding paragraph, preferably polyethylene and polypropylene, can be prepared by different and especially by the following methods:
   a) Radical polymerisation (normally under high pressure and at elevated temperature).
   b) Catalytic polymerisation using a catalyst that normally contains one or more than one metal of groups IVb, Vb, Vlb or VIII of the Periodic Table. These metals usually have one or more than one ligand, typically oxides, halides, alcoholates, esters, ethers, amines, alkyls, alkenyls and/or aryls that may be either a- or Tr-bond coordinated. These metal complexes may be in the free form or fixed on substrates, typically on activated magnesium chloride, titanium(III) chloride, and alumina or silicon oxide. These catalysts may be soluble or insoluble in the polymerisation medium. The catalysts can be used by themselves in the polymerisation or further activators may be used, typically metal alkyls, metal hydrides, metal alkyl halides, metal alkyl oxides or metal alkyloxanes, said metals being elements of groups la, Ila and/or Illa of the Periodic Table. The activators may be modified conveniently with further ester, ether, and amine or silyl ether groups. These catalyst systems are usually termed Phillips, Standard Oil Indiana, Ziegler-Natta), TNZ (DuPont), metallocene or single site catalysts (SSC).
Mixtures of polyolefins, for example mixtures of polypropylene with polyisobutylene, polypropylene with polyethylene (for example PP/HDPE, PP/LDPE) and mixtures of different types of polyethylene (for example LDPE/HDPE).
Copolymers of monoolefins and diolefins with each other or with other vinyl monomers, for example ethylene/propylene copolymers, linear low density polyethylene (LLDPE) and mixtures thereof with low density polyethylene (LDPE), propylene/but-1-ene copolymers, propylene/isobutylene copolymers, ethylene/but-1-ene copolymers, ethylene/hexene copolymers, ethylene/methylpentene copolymers, ethylene/heptene copolymers, ethylene/octene copolymers, ethylene/vinylcyclohexane copolymers, ethylene/cycloolefin copolymers (e.g. ethylene/norbornene like COC), ethylene/1-olefins copolymers, where the 1-olefin is generated in-situ; propylene/butadiene copolymers, isobutylene/isoprene copolymers, ethylene/vinylcyclohexene copolymers, ethylene/alkyl acrylate copolymers, such as ethylene-n-butyl acrylate or methacrylate, ethylene/alkyl methacrylate copolymers, ethylene/vinyl acetate copolymers or ethylene/acrylic acid copolymers and their salts (ionomers) as well as terpolymers of ethylene with propylene and a diene such as hexadiene, dicyclopentadiene or ethylidene-norbornene; and mixtures of such copolymers with one another and with polymers mentioned in 1) above, for example polypropylene/ethylene-propylene copolymers, LDPE/ethylene-vinyl acetate copolymers (EVA), LDPE/ethylene-acrylic acid copolymers (EAA), LLDPE/EVA, LLDPE/EAA and alternating or random polyalkylene/carbon monoxide copolymers and mixtures thereof with other polymers, for example polyamides.
2. Hydrocarbon resins (for example C₅-C₉) including hydrogenated modifications thereof (e.g. tackifiers) and mixtures of polyalkylenes and starch; The homopolymers and copolymers mentioned above may have a stereo structure including syndiotactic, isotactic, hemi-isotactic or atactic; where atactic polymers are preferred. Stereo block polymers are also included.
3. Aromatic homopolymers and copolymers (comprising graft copolymers) derived from vinyl aromatic monomers including styrene, p-methylstyrene, a-methylstyrene, all isomers of vinyl toluene, especially p-vinyl toluene, all isomers of ethyl styrene, propyl styrene, vinyl biphenyl, vinyl naphthalene, and vinyl anthracene, and mixtures thereof. Homopolymers and copolymers may have a stereo structure including syndiotactic, isotactic, hemi-isotactic or atactic; where atactic polymers are preferred. Stereo block polymers are also included;
   a) Copolymers including aforementioned vinyl aromatic monomers and comonomers selected from ethylene, propylene, dienes, nitriles, acids, maleic anhydrides, maleimides, vinyl acetate and vinyl chloride or acrylic derivatives and mixtures thereof, for example styrene/butadiene, styrene/acrylonitrile, styrene/ethylene (interpolymers), styrene/alkyl methacrylate, styrene/butadiene/alkyl acrylate, styrene/butadiene/alkyl methacrylate, styrene/maleic anhydride, styrene/acrylonitrile/methyl acrylate; mixtures of high impact strength of styrene copolymers and another polymer, for example a polyacrylate, a diene polymer or an ethylene/propylene/diene terpolymer; and block copolymers of styrene such as styrene/butadiene/styrene, styrene/isoprene/styrene, styrene/ethylene/butylene/styrene or styrene/ethylene/propylene/styrene.
   b) Hydrogenated aromatic polymers derived from hydrogenation of polymers mentioned under 3.), especially including polycyclohexylethylene (PCHE) prepared by hydrogenating atactic polystyrene, often referred to as polyvinylcyclohexane (PVCH).
   c) Hydrogenated aromatic polymers derived from hydrogenation of polymers mentioned under 3a). Homopolymers and copolymers may have a stereo structure including syndiotactic, isotactic, hemi-isotactic or atactic; where atactic polymers are preferred. Stereo block polymers are also included.
Graft copolymers of vinyl aromatic monomers, such as styrene or a-methylstyrene, for example styrene on polybutadiene, styrene on polybutadiene-styrene or polybutadiene-acrylonitrile copolymers; styrene and acrylonitrile (or methacrylonitrile) on polybutadiene; styrene, acrylonitrile and methyl methacrylate on polybutadiene; styrene and maleic anhydride on polybutadiene; styrene, acrylonitrile and maleic anhydride or maleimide on polybutadiene; styrene and maleimide on polybutadiene; styrene and alkyl acrylates or methacrylates on polybutadiene; styrene and acrylonitrile on ethylene/propylene/diene terpolymers; styrene and acrylonitrile on polyalkyl acrylates or polyalkyl methacrylates, styrene and acrylonitrile on acrylate/butadiene copolymers, as well as mixtures thereof with the copolymers listed under 3), for example the copolymer mixtures known as ABS, MBS, ASA or AES polymers.
4. Halogen-containing polymers such as polychloroprene, chlorinated rubbers, chlorinated and brominated copolymer of isobutylene-isoprene (halobutyl rubber), chlorinated or sulphochlorinated polyethylene, copolymers of ethylene and chlorinated ethylene, epichlorohydrin homo- and copolymers, especially polymers of halogen-containing vinyl compounds, for example polyvinyl chloride, polyvinylidene chloride, polyvinyl fluoride, polyvinylidene fluoride, as well as copolymers thereof such as vinyl chloride/vinylidene chloride, vinyl chloride/vinyl acetate or vinylidene chloride/vinyl acetate copolymers.
5. Polymers derived from a,8-unsaturated acids and derivatives thereof such as polyacrylates and polymethacrylates; polymethyl methacrylates, polyacrylamides and polyacrylonitriles, impact-modified with butyl acrylate.

Copolymers of the monomers mentioned under 5) with each other or with other unsaturated monomers, for example acrylonitrile/ butadiene copolymers, acrylonitrile/alkyl acrylate copolymers, acrylonitrile/alkoxyalkyl acrylate or acrylonitrile/vinyl halide copolymers or acrylonitrile/ alkyl methacrylate/butadiene terpolymers.
6. Polymers derived from unsaturated alcohols and amines or the acyl derivatives or acetals thereof, for example polyvinyl alcohol, polyvinyl acetate, polyvinyl stearate, polyvinyl benzoate, polyvinyl maleate, polyvinyl butyral, polyallyl phthalate or polyallyl melamine; as well as their copolymers with olefins mentioned in 1 above.
7. Homopolymers and copolymers of cyclic ethers such as polyalkylene glycols, polyethylene oxide, polypropylene oxide or copolymers thereof with bisglycidyl ethers.
8. Polyacetals such as polyoxymethylene and those polyoxymethylenes, which contain ethylene oxide as a co-monomer; polyacetals modified with thermoplastic polyurethanes, acrylates or MBS.
9. Polyphenylene oxides and sulphides, and mixtures of polyphenylene oxides with styrene polymers or polyamides.
10. Polyamides and co-polyamides, such as those derived from diamines and dicarboxylic acids and/or from aminocarboxylic acids or the corresponding lactams, for example polyamide 4, polyamide 6 (PA6), polyamide 6/6, 6/10, 6/9, 6/12, 4/6, 12/12, polyamide 11 (PA11), polyamide 12 (PA12), aromatic polyamides starting from m-xylene diamine and adipic acid; polyamides prepared from hexamethylenediamine and isophthalic or/and terephthalic acid and with or without an elastomer as modifier, for example poly-2,4,4,-trimethylhexamethylene terephthalamide or poly-m-phenylene isophthalamide; and also block copolymers of the aforementioned polyamides with polyolefins, olefin copolymers, ionomers or chemically bonded or grafted elastomers; or with polyethers, e.g. with polyethylene glycol, polypropylene glycol or polytetramethylene glycol; as well as polyamides or co-polyamides modified with EPDM or ABS; and polyamides condensed during processing (RIM polyamide systems).

11. Polyureas, polyimides, polyamide imides, polyether imides, polyester imides, polyhydantoins and polybenzimidazoles.

12. Polyesters, such as those derived from dicarboxylic acids and diols and/or from hydroxycarboxylic acids or the corresponding lactones, for example polyethylene terephthalate, polybutylene terephthalate, poly-1,4-dimethylolcyclohexane terephthalate, polyalkylene naphthalate (PAN) and polyhydroxybenzoates, as well as block co-polyether esters derived from hydroxyl-terminated polyethers; and also polyesters modified with polycarbonates or MBS.

13. Polyketones.

14. Polysulphones, polyether sulphones and polyether ketones. Polycarbonates that correspond to the general formula:

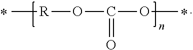

Such polycarbonates are obtainable by interfacial processes or by melt processes (catalytic transesterification). The polycarbonate may be either branched or linear in structure and may include any functional substituents. Polycarbonate copolymers and polycarbonate blends are also within the scope of the invention. The term polycarbonate should be interpreted as inclusive of copolymers and blends with other thermoplastics. Methods for the manufacture of polycarbonates are known, for example, from U.S. Patent Specification Nos.

3,030,331; 3,169,121; 4,130,458; 4,263,201; 4,286,083; 4,552,704; 5,210,268; and A combination of two or more polycarbonates of different molecular weights may be used.

Preferred are polycarbonates obtainable by reaction of a diphenol, such as bisphenol A, with a carbonate source. Examples of suitable diphenols are:

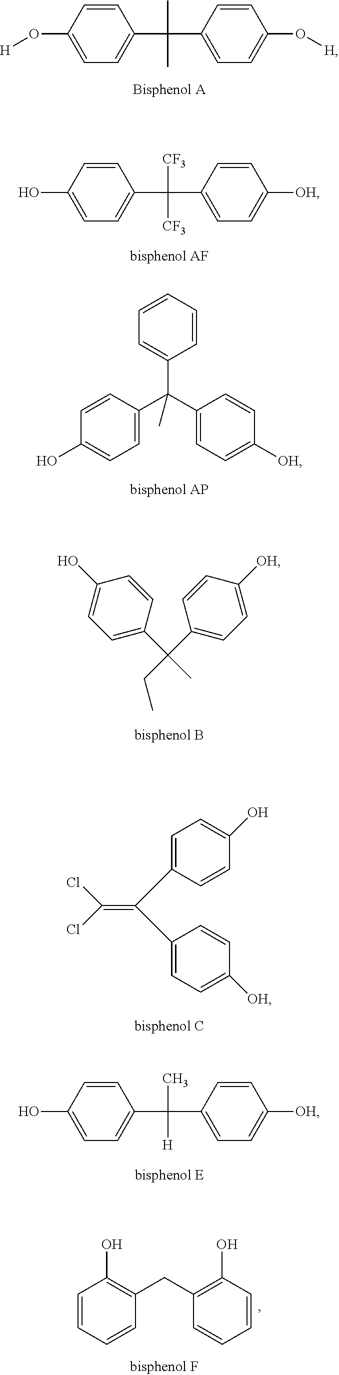

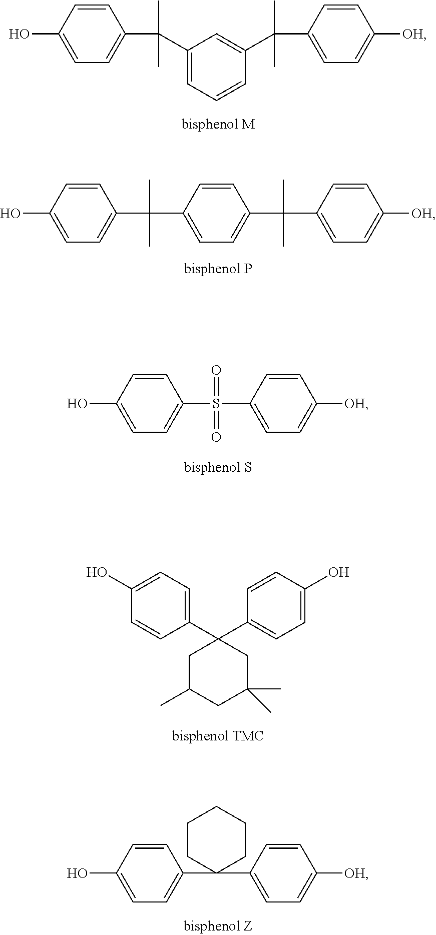 [SMILES: CC(C)(c1ccc(O)cc1)c1cccc(C(C)(C)c2ccc(O)cc2)c1 ; CC(C)(c1ccc(O)cc1)c1ccc(C(C)(C)c2ccc(O)cc2)cc1 ; O=S(=O)(c1ccc(O)cc1)c1ccc(O)cc1 ; CC1CC(C)(C)CC(c2ccc(O)cc2)(c2ccc(O)cc2)C1 ; Oc1ccc(C2(c3ccc(O)cc3)CCCCC2)cc1]

4,4′-(2-norbornylidene)bis(2,6-dichlorophenol); or fluorene-9-bisphenol:

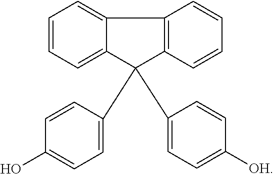 [SMILES: Oc1ccc(C2(c3ccc(O)cc3)c3ccccc3-c3ccccc32)cc1]

The carbonate source may be a carbonyl halide, a carbonate ester or a haloformate. Suitable carbonate halides are phosgene or carbonylbromide. Suitable carbonate esters are WO 2022/106402 14 PCT/EP2021/081817 dialkylcarbonates, such as dimethyl- or diethylcarbonate, diphenyl carbonate, phenyl-alkyl-phenylcarbonate, such as phenyl-tolylcarbonate, dialkylcarbonates, such as dimethyl- or diethylcarbonate, di-(halophenyl)carbonates, such as di-(chlorophenyl)carbonate, di-(bromo-phenyl)carbonate, di-(trichlorophenyl)carbonate or di-(trichlorophenyl)carbonate, di-(alkyl-phenyl)carbonates, such as di-tolylcarbonate, naphthylcarbonate, dichloro-naphthylcarbonate and others.

16. Polyurethanes, such as those derived from hydroxyl-terminated polyethers, polyesters or polybutadienes on the one hand and aliphatic or aromatic polyisocyanates on the other, as well as precursors thereof.

17. Blends of the aforementioned polymers (polyblends), for example PP/EPDM, Polyamide/EPDM or ABS, PVC/EVA, PVC/ABS, PVC/MBS, PC/ABS, PBTP/ABS, PC/ASA, PC/PBT, PVC/CPE, PVC/acrylates, POM/thermoplastic PUR, PC/thermoplastic PUR, POM/acrylate, POM/MBS, PPO/HIPS, PPO/PA 6.6 and copolymers, PA/HDPE, PA/PP,

PA/PPO, PBT/PC/ABS or PBT/PET/PC.

Other polymers may additionally contain in the form as admixtures or as copolymers a wide variety of synthetic polymers including polyolefins, polystyrenes, polyesters, polyethers, polyamides, poly(meth)acrylates, thermoplastic polyurethanes, polysulphones, polyacetals and

PVC, including suitable compatibilizing agents. For example, the component (c) may additionally contain thermoplastic polymers selected from the group of resins consisting of polyolefins, thermoplastic polyurethanes, styrene polymers and copolymers thereof. Specific embodiments include polypropylene (PP), polyethylene (PE), polyamide (PA), polybutylene terephthalate (PBT), polyethylene terephthalate (PET), glycol-modified polycyclohexylenemethylene terephthalate (PCTG), polysulphone (PSU), polymethylmethacrylate (PMMA), thermoplastic polyurethane (TPU), acrylonitrile-butadiene-styrene (ABS), acrylonitrile-styrene-acrylic ester (ASA), acrylonitrile-ethylene-propylene-styrene (AES), styrene-maleic anhydride (SMA) or high impact polystyrene (HIPS).

According to a preferred embodiment, the thermoplastic polymer is selected from the group consisted of polyamides and co-polyamides, polyolefins (such as polypropylene), polyester and polyurethanes.

35 According to the present invention, the average particle size (D 50) of the thermoplastic polymer can be in the range from 0.1 to 1000 pm, for example from 0.1 to 500 pm or from 0.1 to 300 pm, or from 0.1 to 200 pm.

The amount of the thermoplastic polymer can be in the range from 20 to 94 wt. %, for example 40 30 wt. %, 40 wt. %, 50 wt. %, 60 wt. %, 70 wt. %, 80 wt. %, 85 wt. %or 90 wt. %, preferably from 30 to 90 wt. %, from 50 to 90 wt. %or from 50 to 85 wt. %, based on the total weight of the pulverulent composition.

In one embodiment, the pulverulent composition of the present invention comprising

WO 2022/106402 15 PCT/EP2021/081817 (a) 0.1 to 30 wt. %of at least one phosphate flame retardant synergist selected from hydrogen phosphate salt, dihydrogen phosphate salt, hydrate thereof and mixture thereof; (b) 5 to 60 wt. %of at least one flame retardant; and (c) 20 to 94 wt. %of at least one thermoplastic polymer.

In one embodiment, the pulverulent composition of the present invention comprising (a) 1 to 20 wt. %of at least one phosphate flame retardant synergist selected from hydrogen phosphate salt, dihydrogen phosphate salt, hydrate thereof and mixture thereof; (b) 5 to 60 wt. %of at least one flame retardant; and 10 (c) 20 to 94 wt. %of at least one thermoplastic polymer.

In one embodiment, the pulverulent composition of the present invention comprising (a) 0.1 to 30 wt. %of at least one phosphate flame retardant synergist selected from hydrogen phosphate salt, dihydrogen phosphate salt, hydrate thereof and mixture thereof; 15 (b) 10 to 50 wt. %of at least one flame retardant; and (c) 30 to 85 wt. %of at least one thermoplastic polymer.

In one embodiment, the pulverulent composition of the present invention comprising (a) 1 to 20 wt. %of at least one phosphate flame retardant synergist selected from hydrogen 20 phosphate salt, dihydrogen phosphate salt, hydrate thereof and mixture thereof;

(b) 10 to 30 wt. %of at least one flame retardant; and (c) 50 to 85 wt. %of at least one thermoplastic polymer.

In one embodiment, the pulverulent composition of the present invention comprising 25 (a) 5 to 20 wt. %of at least one phosphate flame retardant synergist selected from hydrogen phosphate salt, dihydrogen phosphate salt, hydrate thereof and mixture thereof; (b) 10 to 30 wt. %of at least one flame retardant; and (c) 50 to 85 wt. %of at least one thermoplastic polymer.

30 In one preferred embodiment, the pulverulent composition according to the present invention further comprises at least one flowing agent. The flowing agent can be aluminum oxide, silicon dioxide, or titanium dioxide, for example fumed silica, colloidal silica, fumed aluminum oxide. Suitable flowing agent may be added to the pulverulent composition.

The average particle size (D 50) of the flowing agent can be less than 300 pm.

The amount of the flowing agent can be in the range from 0.05 to 8 wt. %, for example 0.08 wt. %, 0.1 wt. %, 0.2 wt. %, 0.5 wt. %, 0.8 wt. %, 1 wt. %, 1.2 wt. %, 1.5 wt. %, 1.8 wt. %, 2 wt. %, 2.5 wt. %, 3 wt. %, 4 wt. %, 5 wt. %, 6 wt. %, 7 wt. %, preferably from 0.1 to 5 wt. %.

According to an embodiment of the invention, the composition may further comprise one or more auxiliaries.

As auxiliaries, mention may be made by way of preferred example of surface-active substances, nucleating agents, lubricant wax, dyes, pigments, catalyst, UV absorbers and stabilizers, e.g. against oxidation, hydrolysis, light, heat or discoloration, inorganic and/or organic fillers and reinforcing materials. As hydrolysis inhibitors, preference is given to oligomeric and/or polymeric aliphatic or aromatic carbodiimides. To stabilize 3D-printed objects of the invention against aging and damaging environmental influences, stabilizers are added to system in preferred embodiments. Examples of the inorganic and/or organic fillers and reinforcing materials can include glass bead, glass fiber and carbon fiber.

If the composition of the invention is exposed to thermo-oxidative damage during use, in preferred embodiments antioxidants are added. Preference is given to phenolic antioxidants. Phenolic antioxidants such as Irganox® 1010 from BASF SE are given in Plastics Additive Handbook, 5th edition, H. Zweifel, ed., Hanser Publishers, Munich, 2001, pages 98-107, page 116 and page 121.

If the composition of the invention is exposed to UV light, it is preferably additionally stabilized with a UV absorber. UV absorbers are generally known as molecules which absorb high-energy UV light and dissipate energy. Customary UV absorbers which are employed in industry belong, for example, to the group of cinnamic esters, diphenylcyan acrylates, formamidines, benzylidenemalonates, diarylbutadienes, triazines and benzotriazoles. Examples of commercial UV absorbers may be found in Plastics Additive Handbook, 5th edition, H. Zweifel, ed, Hanser Publishers, Munich, 2001, pages 116-122.

Further details regarding the abovementioned auxiliaries may be found in the specialist literature, e.g. in Plastics Additive Handbook, 5th edition, H. Zweifel, ed, Hanser Publishers, Munich, 2001.

In a preferred embodiment of the invention, auxiliaries are if any, present in an amount of from to 50 wt. %, for example 0.5 to 30 wt. %, based on the total weight of the pulverulent composition.

One aspect of the present disclosure relates to a process for preparing the pulverulent composition, which comprises:
(1) providing the powders of the above components (a), (b) and (c) and optionally flowing agent and optionally auxiliaries, and
(2) dry blending the powders under stirring.

According to an embodiment of the invention, the blending is carried out at room temperature with stirring. There is no particular restriction on the time of blending and rate of stirring, as long 40 as the all components are uniformly mixed together. In a specific embodiment, the mixing is performed by means of a mixer at 800 to 3000 RPM, preferably 1000 to 2000 RPM for 30 seconds to 15 min, more preferably from 45 seconds to 5 min.

In a further aspect, the invention relates to a 3D-printed object formed from the pulverulent composition of the present invention.

According to an embodiment of the invention, the example of 3D-printed objects includes for example, sole, outerwear, cloth, footwear, toy, mat, tire, hose, gloves, seals.

In a further aspect, the invention relates to a process of forming 3D-printed object, comprising using the above pulverulent composition as the raw material for 3D-printing.

In an embodiment, the process comprises:
a) adding the pulverulent composition according to the present invention to a molding mixture, and
b) producing the molding by selectively bonding the powder.

In a preferred embodiment, the molding produced in step b) is produced by a process for the layer-by-layer build-up of three-dimensional objects by selectively bonding portions of a powder to on another.

According to the present invention, the selectively bonding comprises selective laser sintering, selective inhibition of the bonding of powders, 3D printing, or a microwave process.

### Examples

Materials
Thermoplastic powder:
PA11: Adsint PA 11 Nat. from BASF 3D Printing Solutions GmbH, the average particle size (D₅₀) is 49 μm;
PA12: Adsint PA 12 from BASF 3D Printing Solutions GmbH, the average particle size (D₅₀) is 38 μm;
PA6: Ultrasint PA 6 X028 from BASF, the average particle size (D₅₀) is 70 μm.
Flame-retardant:
Exolit OP1400: Diethyl aluminum hypophosphite, from Clariant Plastics & Coatings (Deutschland) GmbH, the average particle size (D₅₀) is 26 μm;
Exolit OP1230: Diethyl aluminum hypophosphite, from Clariant Plastics & Coatings (Deutschland) GmbH, the average particle size (D₅₀) is 30 μm;
Exolit AP422: Ammonium polyphosphate, from Clariant Plastics & Coatings (Deutschland) GmbH, the average particle size (D₅₀) is 17 μm;
MPP200 70: Melamine polyphosphate, from BASF, the average particle size (D 50) is 12 pm.
Phosphate flame retardant synergist:

a-ZrP: Zr(HPO 4) 2 .H 2 0, from Sunshine Factory Co., Ltd., the average particle size (D 50) is 15 μm;
Al(H₂PO₄)3: from Shanghai Aladdin biochemical technology Co., Ltd, the average particle size (D₅₀) is 248 μm.

Methods
All samples were printed by Farsoon HT251 SLS 3D printer.
Tensile strength, tensile modulus and elongation at break were measured at a rate of 6 mm/min (according to IS0527-21/A15 2012) by Zwick Z050. The samples were tested without condition.
Limiting oxygen index (LOI) was tested by ATS FAAR LOI Test Apparatus according to ISO 4589-2:1999 method. The samples were tested without conditioning.
UL-94 vertical burning was tested by ATS FAAR UL94 Test Apparatus according to UL94-sixth edition standard. The UL94 testing samples were conditioned under 23±2° C., 50±5% RH for at least 48 hrs.

Examples 1a, 1b, 1c, 1d, 2a, 2b, 3a, 3b, 4a, 4b, 5 — Preparind the pulverulent composition.

The pulverulent compositions in examples 1a, 1b, 1c, 1d, 2a, 2b, 3a, 3b, 4a, 4b, 5 were pre- pared by mixing the powders of the thermoplastic polymer, flame retardant and phosphate flame retardant synergist. The blending experiments were carried out on the HTS-5 High speed mixer from Dongguan Huanxin Machinery Co., Ltd. Each component was weighted according to the amounts as shown in table 1. The powders were mixed under 1400 rpm for 60 seconds to obtain the pulverulent composition.

TABLE 1
the amount of each component

| | PA 11 | PA 6 | PA12 | OP1230 | OP1400 | MPP 200/70 | AP422 | Zr(HPO₄)₂•H₂O | Al(H₂PO₄)₃ |
|---|---|---|---|---|---|---|---|---|---|
| example | (g) | (g) | (g) | (g) | (g) | (g) | (g) | (g) | (g) |
| 1a | 8500 | | | | 1500 | | | | |
| 1b | 8000 | | | | 1500 | | | 500 | |
| 1c | 8000 | | | | 2000 | | | | |
| 1d | 8000 | | | | | | | 2000 | |
| 2a | 8000 | | | 2000 | | | | | |
| 2b | 7000 | | | 2000 | | | | 1000 | |
| 3a | | 7500 | | | | 2500 | | | |
| 3b | | 7000 | | | | 2500 | | 500 | |
| 4a | | | 8000 | | | | 2000 | | |
| 4b | | | 7500 | | | | 2000 | | 500 |
| 5 | 6000 | | | 2000 | | | | 2000 | |

The pulverulent compositions in examples 1b, 2b, 3b, 4b and 5 comprise both flame retardant and phosphate flame retardant synergist and thus are examples according to the present invention.

Example 6—3D printing

The pulverulent compositions prepared in examples 1a, 1b, 1c, 1d, 2a, 2b, 3a, 3b, 4a, 4b, 5 were printed by HT251 Selective Laser Sintering 3D printer which was manufactured from Far- soon. For a typical printing process, 10 kg pulverulent composition were loaded in the feed chamber of the printer. For all printing processes, the printing parameters need to be adjusted according to different type of pulverulent compositions and their cracking or warping phenome- non during printing process. Detailed printing parameters for each pulverulent composition were listed in the table 2.

Post-treatment process: Once the printing process was completed and the printed objects were cooled, the build chamber was removed from the printer and transferred to a cleaning station, the printed objects were separated from the excess powders to obtain the final 3D-printed objects.

TABLE 2
Printing parameters for the compositions from examples 1a, 1b, 1c, 1d, 2a, 2b, 3a, 3b, 4a, 4b, 5

| | | | | | | Outline | Laser | | | Laser | |
|---|---|---|---|---|---|---|---|---|---|---|---|
| | Part | | | | Laser | laser | scan | | Roller | scan | Layer |
| | bed T | Feed T | Piston T | Cylinder T | power | power | spacing | Scan | speed | speed | thickness |
| Example | (° C.) | (° C.) | (° C.) | (° C.) | (W) | (W) | (mm) | count | (mm/s) | (m/s) | (mm) |
| 1a | 187.5 | 150 | 170 | 170 | 45 | 7 | 0.2 | 1 | 180 | 7.62 | 0.1 |
| 1b | 187.5 | 150 | 170 | 170 | 45 | 7 | 0.2 | 1 | 180 | 7.62 | 0.1 |
| 1c | 187.5 | 150 | 170 | 170 | 45 | 7 | 0.2 | 1 | 180 | 7.62 | 0.1 |
| 1d | 187.5 | 150 | 170 | 170 | 45 | 7 | 0.2 | 1 | 180 | 7.62 | 0.1 |
| 2a | 187.5 | 150 | 170 | 170 | 45 | 7 | 0.2 | 1 | 180 | 7.62 | 0.1 |
| 2b | 187.5 | 150 | 170 | 170 | 45 | 7 | 0.2 | 1 | 180 | 7.62 | 0.1 |
| 3a | 208.5 | 150 | 200 | 185 | 24 | 7 | 0.16 | 1 | 180 | 7.62 | 0.1 |
| 3b | 208.5 | 150 | 200 | 185 | 24 | 7 | 0.16 | 1 | 180 | 7.62 | 0.1 |
| 4a | 169 | 140 | 150 | 150 | 35 | 7 | 0.2 | 1 | 180 | 7.62 | 0.1 |
| 4b | 169 | 140 | 150 | 150 | 35 | 7 | 0.2 | 1 | 180 | 7.62 | 0.1 |
| 5 | 188.5 | 150 | 170 | 170 | 45 | 7 | 0.2 | 1 | 180 | 7.62 | 0.1 |

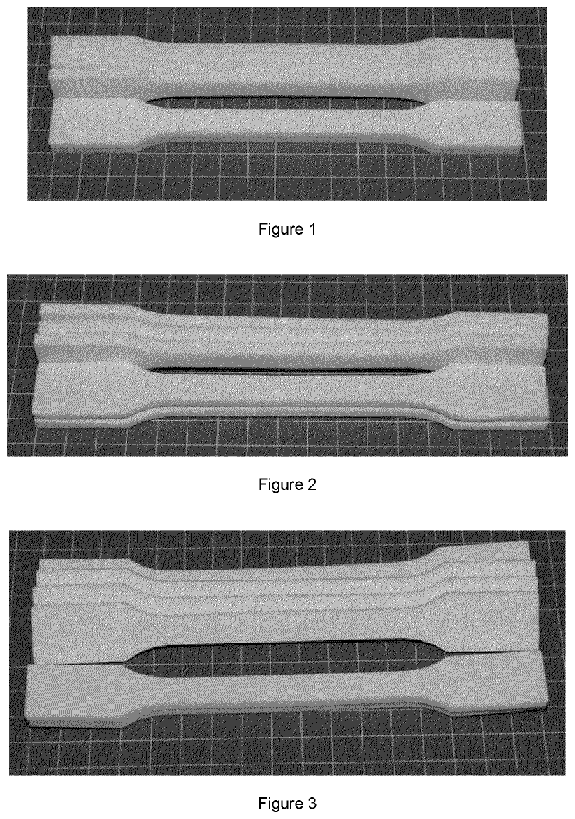

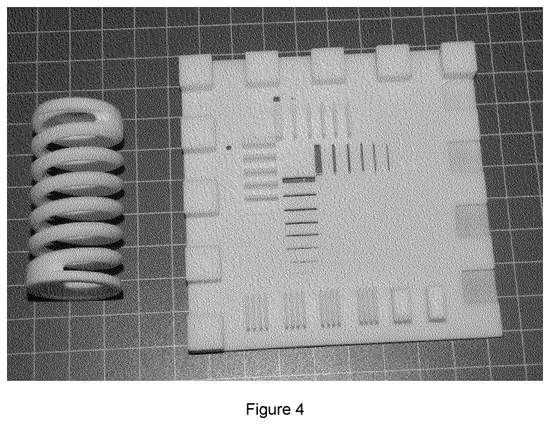

Pictures of printed samples prepared from the pulverulent compositions of example 1 b, example 2b and example 3b were shown in FIG. 1, FIG. 2 and FIG. 3, respectively. Other objects formed from the pulverulent composition of example 2b were shown in FIG. 4. As can be seen, the pulverulent compositions of example 1b, example 2b and example 3b could be successfully used to form 3D-printed objects, and the compositions exhibited good printing accurate and performance, which means the pulverulent compositions according to the present invention have excellent printability.

The bars printed for testing mechanical properties, flame retardant properties and Limiting oxygen index (LOI) have dimensions of 3.2×10×80 mm, 1.6×10×80 mm, 0.8×10×80 mm.

The mechanical properties, flame retardant properties and Limiting oxygen index (LOI) of all printed samples were tested and the results were summarized in table 3.

TABLE 3
mechanical properties, flame retardant properties and LOI of all printed samples

| | Young's Modulus | Tensile Strength | Elongation at | UL94 (thickness | |
|---|---|---|---|---|---|
| Example | (MPa) | (MPa) | break (%) | of sample) | LOI |
| 1a | 1777 | 36.5 | 26 | Fail VB | 27.1 |
| | | | | (3.2 mm) | |
| 1b | 2016 | 36.1 | 18 | V-1 | 28.3 |
| | | | | (3.2 mm) | |
| 1c | 1890 | 31.5 | 16 | V-1 | 29.2 |
| | | | | (3.2 mm) | |
| 1d | 2064 | 45.2 | 15 | Fail VB | 23.2 |
| | | | | (3.2 mm) | |
| 2a | 1860 | 30.6 | 22 | Fail VB | 29.8 |
| | | | | (0.8 mm) | |
| 2b | 1825 | 26.3 | 18 | V-1 | 38.5 |
| | | | | (0.8 mm) | |
| 3a | 4476 | 59.8 | 2.0 | Fail VB | 30.1 |
| | | | | (1.6 mm) | |
| 3b | 4874 | 56.7 | 1.7 | V-2 | 31.5 |
| | | | | (1.6 mm) | |
| 4a | 2034 | 35.9 | 5.5 | Fail VB | 27.5 |
| | | | | (1.6 mm) | |
| 4b | 2170 | 28.8 | 1.8 | V-1 | 28.6 |
| | | | | (1.6 mm) | |
| 5 | 2096 | 21.9 | 5 | V-0 | 34.1 |
| | | | | (0.8 mm) | |

As can be seen, the printed objects obtained from pulverulent compositions of examples 1 b, 2b, 3b, 4b and 5 not only show excellent flame-retardant properties but also have good mechanical properties. The good mechanical properties achieved by these printed objects also means that these pulverulent compositions of examples 1 b, 2b, 3b, 4b and 5 have good printability. The pulverulent compositions of example la, 2a, 3a and 4a only contain flame retardant, the pulverulent composition of example ld only contains phosphate flame retardant synergist and the re- sulted 3D-printed objects show insufficient flame-retardant performance.

1-20. (canceled)

21. A pulverulent composition comprising
(a) at least one phosphate flame retardant synergist selected from the group consisting of hydrogen phosphate salt, dihydrogen phosphate salt, hydrate thereof and mixtures thereof;
(b) at least one flame retardant; and
(c) at least one thermoplastic polymer.

22. The pulverulent composition according to claim 21, wherein the hydrogen phosphate salt and dihydrogen phosphate salt are hydrogen phosphate metal salt and dihydrogen phosphate metal salt, respectively.

23. The pulverulent composition according to claim 22, wherein the metal in the hydrogen phosphate metal salt and dihydrogen phosphate metal salt is a metal selected from the group consisted of an alkali metal, alkaline earth metal, the metals of Group IIIA of the Periodic Table of Elements and transition metal.

24. The pulverulent composition according to claim 22, wherein the metal in the hydrogen phosphate metal salt and dihydrogen phosphate metal salt is a metal selected from the group consisted of alkaline earth metal, the metals of the Groups IIIA, IIB, IIIB, IVB and VIII of the Periodic Table of Elements.

25. The pulverulent composition according to claim 21, wherein the amount of component (a) is in the range from 0.1 to 30 wt. %based on the total weight of the pulverulent composition.

26. The pulverulent composition according to claim 21, wherein the flame retardant is selected from the group consisted of phosphorus-based flame retardants, metal hydroxide compounds, melamine-based compounds, antimony compounds, borate compounds, other metal containing flame retardants, silicon-based materials; and mixtures thereof

27. The pulverulent composition according to claim 26, wherein the flame retardant is selected from the group consisted of phosphorus-based flame retardants and melamine-based compounds.

28. The pulverulent composition according to claim 21, wherein the amount of the flame retardant as component (b) is in the range from 5 to 60 wt. % based on the total weight of the pulverulent composition.

29. The pulverulent composition according to claim 21, wherein the weight ratio of component (a) to component (b) is in the range from 20:1 to 1:50.

30. The pulverulent composition according to claim 21, wherein the total amount of component (a) and component (b) is in the range from 6 to 70 wt. % based on the total weight of the pulverulent composition.

31. The pulverulent composition according to claim 21, wherein the thermoplastic polymer is selected from the group consisted of polyolefins, hydrocarbon resins, aromatic homopolymers and copolymers derived from vinyl aromatic monomers, halogen-containing polymers, polymers derived from α,β-unsaturated acids and derivatives thereof, polymers derived from unsaturated alcohols and amines or the acyl derivatives or acetals thereof, homopolymers and copolymers of cyclic ethers, polyacetals, polyphenylene oxides and sulphides, polyamides and co-polyamides, polyureas, polyimides, polyamide imides, polyether imides, polyester imides, polyhydantoins, polybenzimidazoles, polyesters, polyketones, polysulphones, polyether sulphones, polyether ketones, polycarbonates, polyurethanes and blends or mixtures of the aforementioned polymers.

32. The pulverulent composition according to claim 21, wherein the thermoplastic polymer is selected from the group consisting of polyamides and co-polyamides, polyolefins, polyester and polyurethanes, and blends or mixtures of the aforementioned polymers.

33. The pulverulent composition according to claim 21, wherein the average particle size (D₅₀) of the thermoplastic polymer is in the range from 0.1 to 1000 μm or from 0.1 to 500 μm or from 0.1 to 300 μm.

34. The pulverulent composition according to claim 21, wherein the amount of the thermoplastic polymer is in the range from 20 to 94 wt. % based on the total weight of the pulverulent composition.

35. The pulverulent composition according to claim 21, wherein the pulverulent composition comprises at least one flowing agent.

36. A 3D-printed object formed from the pulverulent composition according to claim 21.

37. A process of forming 3D-printed object, comprising utilizing the pulverulent composition according to claim 21.

38. The process according to claim 37, wherein the process comprises:
a) adding the pulverulent composition to a molding mixture, and
b) producing the molding by selectively bonding the powder.

39. The process according to claim 38, wherein the molding produced in step b) is produced by a process for the layer-by-layer build-up of three-dimensional objects by selectively bonding portions of a powder to on another.

40. The method according to claim 38, wherein the selectively bonding comprises selective laser sintering, selective inhibition of the bonding of powders, 3D printing, or a microwave process.
